(19) United States
(12) Patent Application Publication
(10) Pub. No.: US 2020/0293333 A1
(43) Pub. Date: Sep. 17, 2020

(54) ELECTRONIC DEVICE, APPLICATION EXECUTION SYSTEM, AND CONTROL METHOD THEREFOR

(71) Applicant: SAMSUNG ELECTRONICS CO., LTD., Gyeonggi-do (KR)

(72) Inventors: Eun-seok KIM, Seoul (KR); Min-ho LEE, Gwacheon-si, Gyeonggi-do (KR)

(21) Appl. No.: 16/082,051

(22) PCT Filed: Feb. 22, 2017
(86) PCT No.: PCT/KR2017/001949

§ 371 Date: Sep. 4, 2018

(30) Foreign Application Priority Data
Mar. 4, 2016 (KR) 10-2016-0026627

(51) Int. Cl. G06F 9/445

(52) U.S. Cl. CPC G06F 9/445

(57) ABSTRACT

Disclosed are an electronic apparatus, an application executing system, and control methods thereof, in which a process of parsing a source code of an application and processes of generating execution data of the application and implementing a follow-up measure about execution of the generated execution data are separately performed when the application is executed, thereby executing an application without using parts of a high specification and/or a java virtual machine (JVM). The electronic apparatus includes a communicator configured to communicate with a plurality of external electronic apparatuses; and a processor configured to receive first parsing data, which corresponds to an event that occurs in a first electronic apparatus, of parsing data of an application stored in the first electronic apparatus from the first electronic apparatus among the plurality of external electronic apparatuses, generate first execution data corresponding to the received first parsing data, and perform a follow-up measure about execution of the generated first execution data.

### TECHNICAL FIELD

The present invention relates to a framework of an Internet of things (IoT), a home network or the like network system, and more particularly to an electronic apparatus, an application executing system, and control methods thereof, in which a framework is provided to separately perform a process of parsing a source code of an application and processes of generating execution data of the application and implementing a follow-up measure about execution of the generated execution data when the application is executed, thereby executing an application without using parts of a high specification and/or a java virtual machine (JVM).

### BACKGROUND ART

An IoT, a home network or the like network system refers to a system that builds an interactive and intellectual cooperative relationship by connecting electronic apparatuses such as a personal computer, a peripheral device, a mobile phone, a home appliance, etc. in a home, an office, etc.

Such a network system is configured to establish a virtual common computing environment, which is called middleware, for the apparatuses typically distributed in the home or in office, and provide an application on to the middleware.

However, in most of apparatuses used in the middleware, a process of parsing a source code of an application and processes of generating execution data such as an actually executable binary file based on the parsed data and implementing a follow-up measure about execution of the generated execution data are performed in a lump to execute an application. For example, to execute an application, a client apparatus receives an actually executable execution file generated by the parsing process and the processes of generating the execution data and implementing the follow-up measure from a server apparatus, or receives a source code of the application from the server apparatus and generates the actually executable execution file by the parsing process and the processes of generating the execution data and implementing the follow-up measure. Therefore, the server or client apparatus needs a central processing unit (CPU) of a high specification and a memory of high capacity for performing the parsing process and the processes of generating the execution data and the follow-up measure in a lump. In result, the manufacturing costs of the server or client apparatus may increase.

Further, when the server or client apparatus connects with a plurality of different apparatuses, a load of Communication Overhead of spending time on communication with the connected apparatuses may increase. However, it is difficult for the server or client apparatus to solve the load of the Communication Overhead since the parsing process and the processes of generating the execution data and implementing the follow-up measure are performed in a lump.

Further, some examples of middleware operate based on an application engine that supports only a specific language. For example, Jini has a java virtual machine (JVM) in which a Java application using a Java language runs. The JVM parses and compiles a source code of the Java application and compiles the parsed source code and converts it into an actually executable native code or machine code. Therefore, each of Jini devices also requires a CPU of a high specification and a memory of high capacity for driving the JVM. In result, the manufacturing costs of the devices may increase. Further, when a plurality of different apparatuses is connected to a specific apparatus, the load of the Communication Overhead may increase. However, the JVM also performs the parsing process and the compiling process in a lump, and it is therefore difficult to solve the load of the Communication overhead. Further, the JVM subjects the application to a Sandbox process in units of script when a runtime error occurs. In this case, the application execution speed of the JVM may slow down.

### DISCLOSURE

### Technical Problem

There are provided an electronic apparatus, an application executing system, and control methods thereof, in which a parsing process and processes of generating execution data and implementing a follow-up measure are separately performed when an application is executed, thereby executing an application without using parts of a high specification and/or a java virtual machine (JVM).

### Technical Solution

According to one aspect of the present invention, an electronic apparatus includes: a communicator configured to communicate with a plurality of external electronic apparatuses; and a processor configured to receive first parsing data, which corresponds to an event that occurs in a first electronic apparatus, of parsing data of an application stored in the first electronic apparatus from the first electronic apparatus among the plurality of external electronic apparatuses, generate first execution data corresponding to the received first parsing data, and perform a follow-up measure about execution of the generated first execution data.

The application may include a script file written based on a script language.

The electronic apparatus may be provided separately from the plurality of external electronic apparatuses. Alternatively, the electronic apparatus may be internally provided in at least one of the plurality of external electronic apparatuses.

Alternatively, the electronic apparatus may further include a storage configured to store a source code of the application. In this case, the processor may generate second parsing data, which corresponds to an event that occurs in a second electronic apparatus, based on the source code of the application stored in the storage when receiving an event signal corresponding to the event that occurs in the second electronic apparatus different from the first electronic apparatus among the plurality of external electronic apparatuses, generate second execution data corresponding to the generated second parsing data, and perform a follow-up measure about execution of the generated second execution data.

The processor may perform a follow-up measure about execution of the generated first and/or second execution data with regard to at least one third electronic apparatus different from the first and/or second electronic apparatus among the plurality of external electronic apparatuses.

Further, the at least one third electronic apparatus may include a plurality of third electronic apparatus, and the electronic apparatus may include a plurality of electronic apparatuses to which the plurality of third electronic apparatuses are distributively connected.

According to another aspect of the present invention, a method of controlling an electronic apparatus includes: receiving first parsing data, which corresponds to an event that occurs in a first electronic apparatus, of parsing data of an application stored in the first electronic apparatus from the first electronic apparatus among the plurality of external electronic apparatuses; generating first execution data corresponding to the received first parsing data; and performing a follow-up measure about execution of the generated first execution data.

Alternatively, the control method of the electronic apparatus further includes: storing a source code of the application; generating second parsing data, which corresponds to an event that occurs in a second electronic apparatus when receiving an event signal corresponding to the event that occurs in the second electronic apparatus different from the first electronic apparatus among the plurality of external electronic apparatuses; generating second execution data corresponding to the generated second parsing data; and performing a follow-up measure about execution of the generated second execution data.

According to still another aspect of the present invention, an electronic apparatus includes: a communicator configured to communicate with a plurality of external electronic apparatuses; and a storage configured to store parsing data of a predetermined application; and a processor configured to determine whether an event occurs, and transmit first parsing data, which corresponds to the event, of the parsing data of the application stored in the storage to a first electronic apparatus among the plurality of external electronic apparatuses when the event occurs.

The storage is configured to classify and store the parsing data of the predetermined application by a predetermined reference. In this case, the predetermined reference may include units of an event, or units of the electronic apparatus.

According to still another aspect of the present invention, a method of controlling an electronic apparatus includes: storing parsing data of a predetermined application; determining whether an event occurs; and transmitting first parsing data, which corresponds to the event, of the parsing data of the stored application to a first electronic apparatus among the plurality of external electronic apparatuses when the event occurs.

The storing may include classifying and storing the parsing data of the predetermined application by a predetermined reference.

According to still another aspect of the present invention, an application executing system includes: a first electronic apparatus configured to determine whether an event occurs and transmit first parsing data, which corresponds to the event, of parsing data of a stored application when the event occurs; and a second electronic apparatus configured to receive the first parsing data from the first electronic apparatus, generate first execution data corresponding to the received first parsing data, and perform a follow-up measure about execution of the generated first execution data.

### DESCRIPTION OF DRAWINGS

FIG. 1 is a block diagram of an application executing system according to an exemplary embodiment,

FIG. 2 is a block diagram of a user terminal apparatus according to an exemplary embodiment,

FIG. 3 illustrates a source code of a service application,

FIG. 4 illustrates an example of a service selection image of a remote control application,

FIG. 5 is a flowchart of a control method of a user terminal according to an exemplary embodiment,

FIG. 6 is a block diagram of a network apparatus according to an exemplary embodiment,

FIG. 7 is a block diagram of a network apparatus according to another exemplary embodiment,

FIG. 8 is a flowchart of a control method of a network apparatus according to an exemplary embodiment,

FIG. 9 is a block diagram of an application executing system according to another exemplary embodiment,

FIG. 10 is a block diagram of a user terminal apparatus according to another exemplary embodiment,

FIG. 11 is a block diagram of a network apparatus according to another exemplary embodiment,

FIG. 12 is a block diagram of a network apparatus according to another exemplary embodiment, and

FIG. 13 is a flowchart of a control method of a network apparatus according to another exemplary embodiment.

### BEST MODE

Below, preferable embodiments of the present invention will be described in detail with reference to accompanying drawings. It will be appreciated that like numerals refer to like elements throughout the drawings.

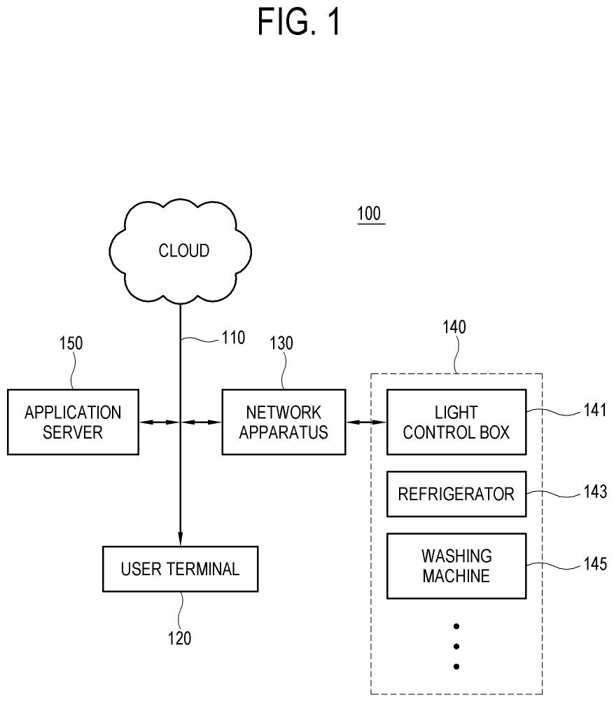

FIG. 1 is a block diagram of an application executing system 100 according to an exemplary embodiment.

The application executing system 100 according to the exemplary embodiment includes a user terminal apparatus 120, a network apparatus 130, and a passive-control apparatus 140 and executes a predetermined application, for example, an application (hereinafter, referred to as a ‘service application’) of providing a service in response to an event that occurs in the user terminal apparatus 120.

Here, the event refers to a user's input or a relevant command signal that makes the passive-control apparatus 140 determine execution of an operation for providing a predetermined service. A predetermined service may include an operation for controlling power-on/off and the like basic functions of the passive-control apparatus 140, and an operation for executing various functions of the passive-control apparatus 140 related to the user terminal apparatus 120.

The user terminal apparatus 120 and the network apparatus 130 are connected through a network 110.

The network 110 may include an apparatus or infrastructure used in performing communication to exchange information about a service corresponding to an event between the user terminal apparatus 120 and the network apparatus 130, and be materialized by a wired and/or wireless network such as Internet, etc.

The user terminal apparatus 120, which refers to an electronic apparatus that generates an event related to a service, may include a mobile terminal or a stationary terminal. The mobile terminal, which refers to an electronic apparatus that is movable to be easily carried, may be materialized by a video phone, a mobile phone, a smart phone, a wideband code division multiple access (WCDMA) user terminal apparatus, a universal mobile telecommunication service (UMTS) user terminal apparatus, a personal digital assistant (PDA), a portable multimedia player (PMP), a digital multimedia broadcasting (DMB) user terminal apparatus, an E-Book, a notebook or tablet computer, a digital camera, a remote controller, etc. Further, the stationary terminal may be materialized by a desktop computer, a personal computer, a server computer, a smart TV, etc.

Below, the following descriptions will be made on the assumption that the user terminal apparatus 120 according to the embodiments is the smart phone.

The network apparatus 130 refers to an electronic apparatus for connecting the passive-control apparatus 140 to the network 110, and is connected to a wired/wireless router and the like access point (AP) of the network 110. Thus, the network apparatus 130 may transmit data related to a service from the user terminal apparatus 120 to the passive-control apparatus 140 through the network 110, and transmit corresponding data received from the passive-control apparatus 140 to the user terminal apparatus 120 through the network 110.

The passive-control apparatus 140, which refers to an electronic apparatus having a communication function for communicating with the network apparatus 130 and the user terminal apparatus 120, may include a light control box, a refrigerator, a washing machine, a TV, a gas valve control device, etc.

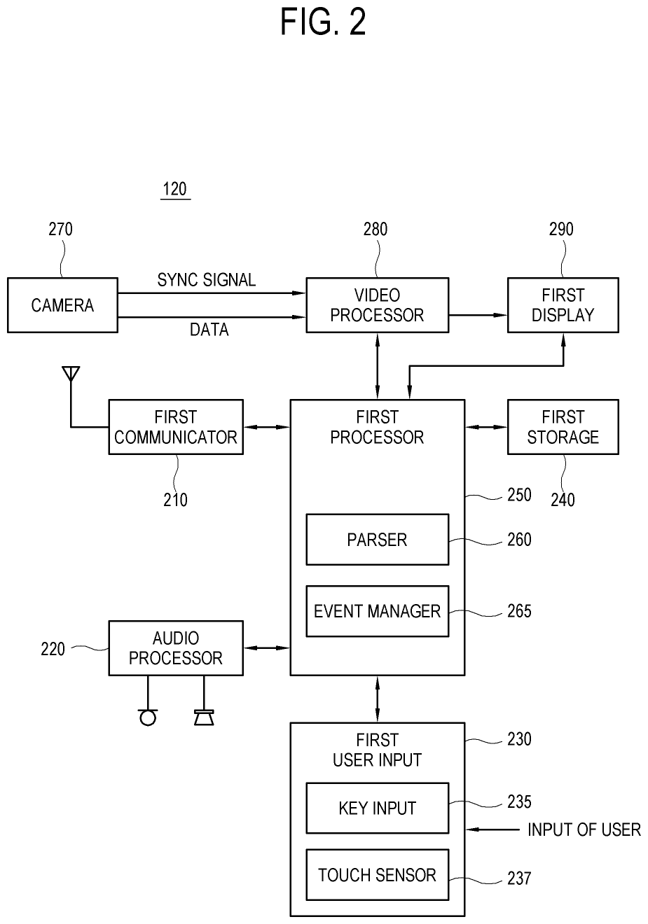

FIG. 2 is a block diagram of the user terminal apparatus 120 according to an exemplary embodiment.

Referring to FIG. 2, the user terminal apparatus 120 according to an embodiment has a parsing function for parsing a code of the service application, and includes a first communicator 210, an audio processor 220, a first user input 230, a first storage 240, a first processor 250, a camera 270, a video processor 280, and a first display 290.

The first communicator 210 forms a channel for communication with the outside and performs a function of transmitting and receiving a wireless signal of data input/output through an antenna under control of the first processor 250. For example, when the wireless signal of the data is transmitted, the data to be transmitted is subjected to channel coding, spreading, and radio frequency (RF) processes. When the wireless signal of the data is received, the received RF signal is converted into a baseband signal and then the baseband signal is subjected to de-spreading and channel decoding so that the data can be restored.

Further, the first communicator 210 may perform publish-subscribe-based communication with the network apparatus 130 and the passive-control apparatus 140 under control of the first processor 250. For example, the first communicator 210 may perform communication based on predetermined identification (ID) information. The ID information may include at least one among Internet protocol (IP) addresses, media access control (MAC) addresses, unique ID, apparatus names, model names, and serial numbers of the network apparatus 130 and the passive-control apparatus 140. The ID information is received from the network apparatus 130 and/or the passive-control apparatus 140 and stored in the first storage 240 when communication connection with the network apparatus 130 and the passive-control apparatus 140 is initially set.

The first communicator 210 may be materialized including a module for short-range wireless communication, for example, a module for at least one among near field communication (NFC), Wireless fidelity (Wi-Fi), Bluetooth, infrared data association (IrDA), ZigBee, a wireless local area network (WLAN), and ultra-wideband (UWB).

The audio processor 220 modulates an audio signal received through a microphone MIC into audio data under control of the first processor 250, and demodulates audio data input from the first communicator 210 and audio data stored in the first storage 240 into an audio signal to thereby output a sound based on the audio signal through a loudspeaker SPK.

The first user input 230 receives a user's input. The first user input 230 may include a key input 235 and/or a touch sensor 237. The key input 235 includes input keys or buttons provided in a front bottom side or a lateral side of a case (not shown) in the user terminal apparatus 120. The key input 235 generates a key signal related to function control of the user terminal apparatus 120 in response to a user's input using the input keys or buttons, and transits the key signal to the first processor 250. The key signal may include a power on/off signal, a volume control signal, etc. The touch sensor 237 is mounted to a front surface of the first display 290, and generates a touch input signal in response to a user's control using a pen, his/her finger or the like touch input tool, thereby transmitting the touch input signal to the first processor 250. The touch sensor 237 may be materialized by a resistive type, a capacitive type, a pressure type, etc.

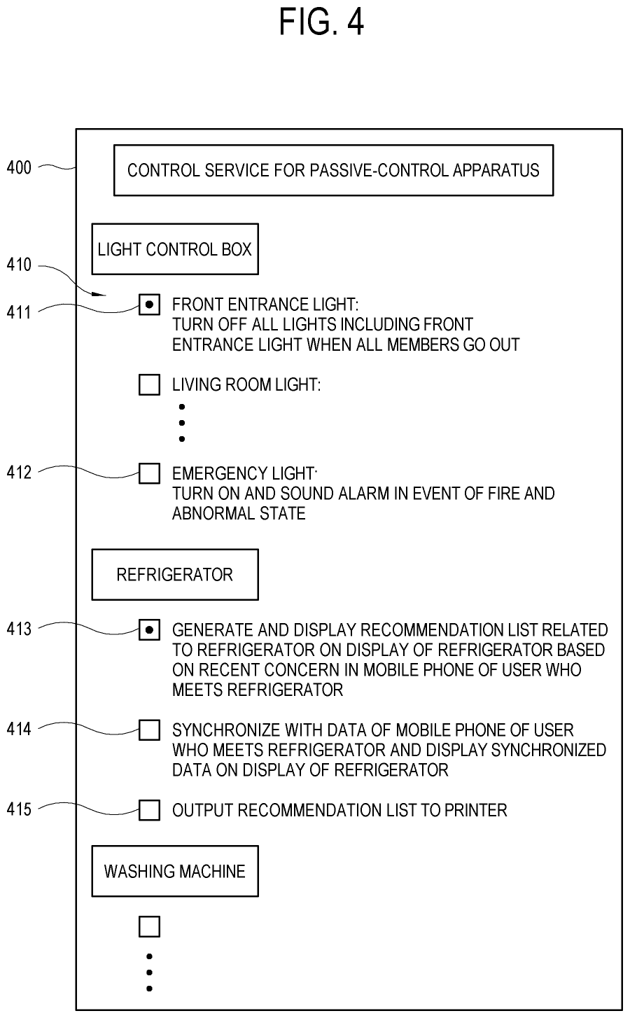

The first storage 240 may include a program memory, and a data memory. The program memory may be configured to store firmware, an operating system or the like control program for controlling the user terminal apparatus 120, and various applications such as a remote control application for controlling the passive-control apparatus 140 to provide a service corresponding to an event. When the remote control application is executed, a service selection image 400 to be described later with reference to FIG. 4 is displayed. The remote control application is programmed to generate a service request signal (hereinafter, referred to as a ‘first service request signal’) corresponding to a selected event selection item 411 and/or 413 when one among a plurality of event selection items 410; 411, 413 is selected on the displayed service selection image 400.

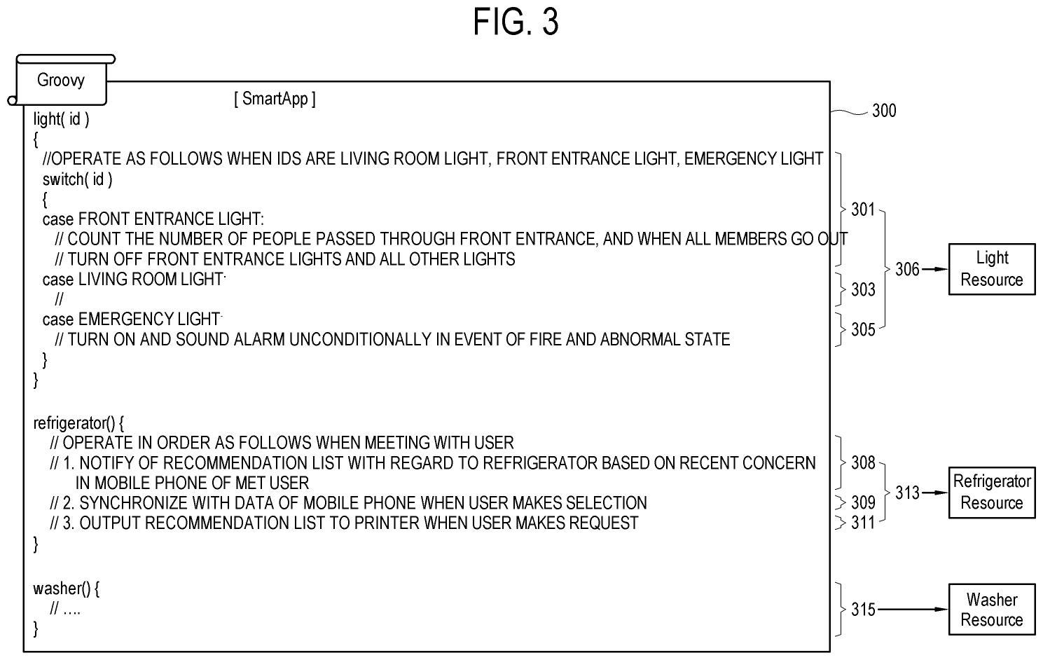

The data memory is configured to store data generated while programs and/or various applications are running. Further, the data memory is configured to store the ID information of the network apparatus 130 and the passive-control apparatus 140, and the source code, the parsing data, etc. of the service application. The source code of the service application may be downloaded from an application server 150 operated by a system builder or a company affiliated with the system builder. Alternatively, the source code of the service application may be directly input and stored by a user. Further, when the user terminal apparatus 120 has a function for writing the service application or includes the application, the source code of the service application may be written and stored in the user terminal apparatus 120. As shown in FIG. 3, a source code 300 of the service application may be written reflecting a user's request and including content for controlling the passive-control apparatus 140 when the application executing system 100 is established. According to an embodiment, the service application may include a script file written based on a script language such as JAVA, Python, Groovy, or JavaScript. The parsing data, such as a parsing tree or a syntax tree obtained by parsing the source code of the service application through a parser 260 of the first processor 250 to be described later may be stored in the first storage 240 in units of the event or the passive-control apparatus, which will be described later.

The first storage 240 may be materialized by a storage medium of at least one type among a flash memory type, a hard disk type, a multimedia card micro type, a card-type memory (e.g. a secure digital (SD) or extreme digital (XD) memory), a random access memory (RAM), a static random access memory (SRAM), a read only memory (ROM), an electrically erasable programmable read-only memory (EEPROM), a programmable read-only memory (PROM), a magnetic memory, a magnetic disc, and an optical disc.

The first processor 250 controls general operations of the user terminal apparatus 120, and in particular controls functions of the user terminal apparatus 120 in response to an input signal received from the first user input 230.

The first processor 250 may include a CPU and a RAM for executing various applications and programs stored in the first storage 240.

Further, the first processor 250 according to the present invention performs the function of parsing the source code of the service application, and the function of transmitting a service request signal, which includes the parsing data corresponding to the event caused by a user's input, to the network apparatus 130.

To this end, the first processor 250 includes the parser 260 and an event manager 265. According to an embodiment, the parser 260 and the event manager 265 may be materialized by programs written based on the C/C++ language.

Alternatively, the parser 260 and the event manager 265 may be materialized by hardware such as an application specific integrated circuit (ASIC).

The parser 260 parses the source code of the service application, downloaded from the application server 150 or input or written by a user, according to grammar rules, and generates the parsing data to be analyzed by the network apparatus 130. In this case, the parsing data may include the parsing tree or the syntax tree.

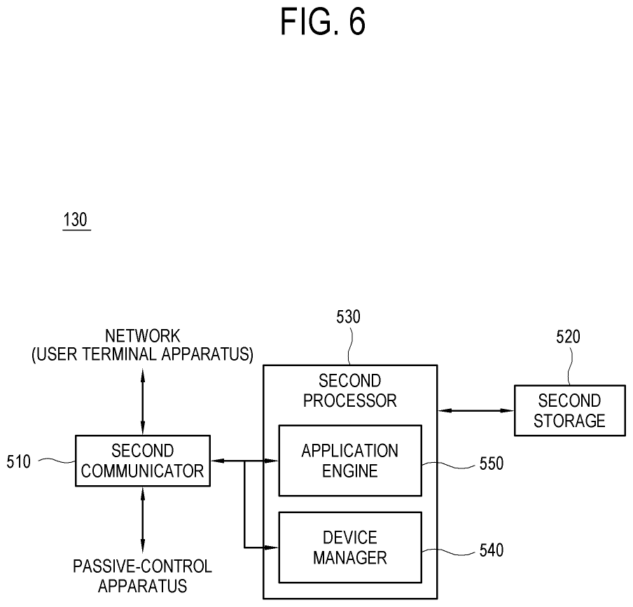

Further, the parser 260 makes the generated parsing data be stored in the first storage 24 in units of the event. In more detail, as shown in FIG. 3, the parsing data is subdivided and stored corresponding to code parts 301, 303, 305, 308, 309, 309, and 311 of the source codes 300 of the service applications corresponding to the events. Therefore, when an event occurs corresponding to a service in response to a user's input using the first user input 230, the event manager 265 transmits parts of the parsing data corresponding to the event to the network apparatus 130 connected to a light control box 141, a refrigerator 143, or a washing machine 145 of the passive-control apparatus 140 providing the corresponding services. The network apparatus 130 processes the received parts of the parsing data and generates execution data to be described later with reference to FIG. 6. In result, the network apparatus 130 may subject the parsing data and/or the corresponding execution data to a Sandbox process in units of the event when a runtime error occurs. Therefore, the network apparatus 130 can process the parsing data and/or the execution data more quickly than the conventional one of subjecting the source code of the service application to the Sandbox process in units of the whole script.

Alternatively, the parsing data may be stored in units of the passive-control apparatus. In more detail, as shown in FIG. 3, the parsing data may be subdivided and stored corresponding to code parts 306, 313 and 315 of the source codes 300 of the service applications corresponding to the light control box 141, the refrigerator 143, and the washing machine 145 of the passive-control apparatus 140. In this case, when the event occurs, the parts of the parsing data corresponding to the event may be transmitted by the event manager 265 to the network apparatus 130 to which the light control box 141, the refrigerator 143 and/or the washing machine 145 of the corresponding passive-control apparatus 140 are connected. In this case, the network apparatus 130 can subject the parsing data and/or the execution data generated corresponding to the parsing data to the Sandbox process in units of the passive-control apparatus when a runtime error occurs.

The event manager 265 displays the service selection image 400 (see FIG. 4) on the first display 290 when the remote control application is executed by a user's input using the first user input 230. The remote control application may be executed by selecting a remote control application icon (not shown) displayed on a Home screen (not shown) of the user terminal apparatus 120. As shown in FIG. 4, the service selection image 400 includes a plurality of event selection items 410 corresponding to parts of the parsing data stored in units of the passive-control apparatus 140 and/or the event. The plurality of event selection items 410 may include a front entrance light-off item 411, an emergency lighting and alarming item 412, a refrigerator recommendation list notification item 413, a mobile-phone data synchronization item 414, a recommendation list output item 415, etc.

When one item, for example, the front entrance light-off item 411 is selected among the plurality of event selection items 410 by a user's input using the first user input 230, the event manager 265 searches for a part of the parsing data corresponding to the code part 301 of the service application related to the front entrance light-off item 411 selected from the parsing data stored in the first storage 240, and generates the first service request signal including the part of the searched parsing data. Here, the front entrance light-off item 411 refers to an item that generates an event for requesting a service of turning off all lights including the front entrance light when all members go out. The event manager 265 transmits the generated first service request signal to the network apparatus 130 to which the corresponding passive-control apparatus 140, i.e. the light control box 141 is connected. In this case, the first service request signal may further include the ID information of the network apparatus 130 to be transmitted in addition to the part of the searched parsing data, and data information related to the selected event selectin item, i.e. the front entrance light-off item 411. The data information may include at least one among the name of the selected front entrance light-off item 411; the name or ID of the parsing data corresponding to the selected front entrance light-off item 411; the IP address, MAC address, unique ID, apparatus name, model name, and serial number of the light control box 141 related to the selected front entrance light-off item 411.

Further, when two or more items, for example, the front entrance light-off item 411 and the refrigerator recommendation list notification item 413 are selected among the plurality of event selection items 410 by a user's input, the event manager 265 generates the first service request signal corresponding to the selected items 411 and 413, and transmits the generated first service request signal to the network apparatus 130 to which the corresponding passive-control apparatuses 140, i.e., the light control box 141 and the refrigerator 143 are connected. The first service request signal to be transmitted includes the ID information of the network apparatus 130, data information related to the selected event selection items 411 and 413, and parts of the parsing data corresponding to the selected event selection items 411 and 413. Here, the refrigerator recommendation list notification item 413 refers to an item that makes a recommendation list related to the refrigerator 143 based on recent interest information in a mobile phone of a user who meets the refrigerator 143 and generates an event for requesting a service of displaying the recommendation list on the display of the refrigerator 143.

Referring back to FIG. 2, the camera 270 includes a camera sensor for capturing image data and converting an optical signal into an electric signal, and a signal processor for converting an analog video signal captured by the camera sensor into digital data.

The video processor 280 performs image signal processing (ISP) for making a video signal output from the camera 270 be displayed on the first display 290.

The first display 290 displays an image based on the video signal output from the video processor 280, and data output from the first processor 250. Here, the first display 290 may be materialized by a liquid crystal display (LCD). In this case, the first display 290 may include an LCD processor (or LCD controller), a memory for storing video data, an LCD device, etc.

Further, the first display 290 includes a touch sensor 237 in a front side thereof.

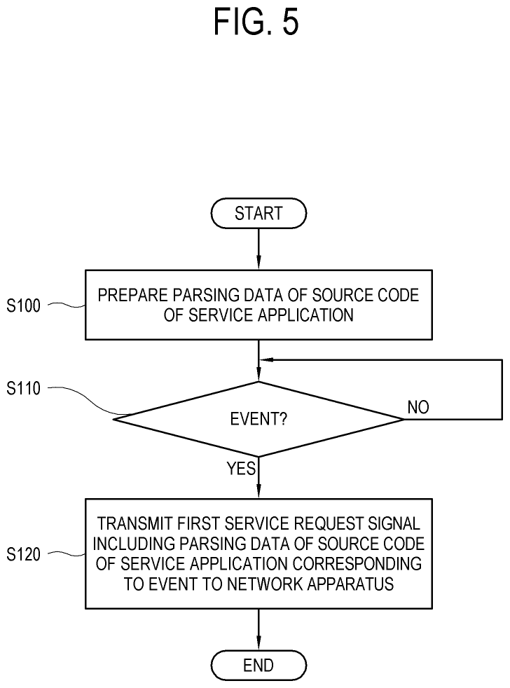

With this configuration, a control method of the user terminal apparatus 120 according to exemplary embodiments will be described below with reference to FIG. 5.

First, the first processor 250 of the user terminal apparatus 120 prepares the parsing data of the source code of the service application (S100). That is, the first processor 250 parses the source code of the service application downloaded from the application server 150 in response to a user's input using the user input 230 or directly input or written by a user, and then stores the parsed parsing data in the first storage 240 in units of the event.

Then, the first processor 250 determines whether the event occurs in the user terminal apparatus 120 (S110). That is, the first processor 250 determines whether a user selects one or more event selection items, for example, the front entrance light-off item 411 corresponding to the functions of the passive-control apparatus 140; 141, 143 145 among the plurality of event selection items 410 on the service selection image 400 displayed after executing the remote control application.

When it is determined in the operation S110 that the event occurs in the user terminal apparatus 120, in other words, when a user selects the front entrance light-off item 411, the first processor 250 reads the parsing data about the code part of the service application corresponding to the front entrance light-off item 411 selected from the parsing data of the source code of the service application stored in the first storage 240. Then, the first processor 250 transmits the first service request signal corresponding to the event related to the selected front entrance light-off item 411 and the parsing data to the network apparatus 130 to which the corresponding passive-control apparatus 140, i.e. the light control box 141 is connected (S130). In this case, the first service request signal includes the ID information of the network apparatus 130 and the data information related to the selected front entrance light-off item 411, to be transmitted in addition to the parsing data corresponding to the selected front entrance light-off item 411.

FIG. 6 is a block diagram of the network apparatus 130 according to an exemplary embodiment.

The network apparatus 130 according to the exemplary embodiment refers to an electronic apparatus such as a hub or a bridge for connecting the passive-control apparatuses 140 to the network 110, and is provided separately from the user terminal apparatus and the passive-control apparatuses 140.

The network apparatus 130 generates the execution data by converting the parsing data of the service application received from the user terminal apparatus 120 into binary format data, and implements a follow-up measure about execution of the generated execution data.

To this end, the network apparatus 130 includes a second communicator 510, a second storage 520, and a second processor 530.

The second communicator 510 refers to a communicator for transmitting and receiving a signal, and is installed in an AP such as a wired/wireless router so as to connect with the network 110 and thus connected to the passive-control apparatus 140 by a wire. According to an embodiment, the second communicator 510 may be materialized by a wired connection module such as a universal serial bus (USB), a mobile high-definition link (MHL), etc.

Like the first communicator 210, the second communicator 510 performs publish-subscribe-based communication with the user terminal apparatus 120 and the passive-control apparatus 140 under control of the second processor 530. That is, the second communicator 510 may perform the communication based on predetermined ID information. The ID information is received from the user terminal apparatus 120 and the passive-control apparatus 140 and stored in the second storage 520 when communication connection with the user terminal apparatus 120 and the passive-control apparatus 140 is initially set under control of the second processor 530.

The second storage 520 may include a program memory, and a data memory. The program memory is configured to store firmware and the like control program for controlling the network apparatus 130. The data memory is configured to store data generated while operations of the network apparatus 130 are performed. For example, the data memory is configured to store the parsing data received from the user terminal apparatus 120, and the execution data generated by an application engine 550 (to be described later) based on the parsing data, in units of the event or the passive-control apparatus, under control of the second processor 530. Further, the data memory is configured to store the ID information of the user terminal apparatus 120 and the passive-control apparatuses 140.

Like the first storage 240, the second storage 520 may be materialized by a storage medium of at least one type among a flash memory type, a hard disk type, a multimedia card micro type, a card-type memory (e.g. a SD or XD memory), a RAM, an SRAM, a ROM, an EEPROM, a PROM, a magnetic memory, a magnetic disc, and an optical disc.

The second processor 530 controls general operations of the network apparatus 130 as a main controller of the network apparatus 130. The second processor 530 may include a CPU and a RAM for executing various applications and programs stored in the first storage 520.

Further, the second processor 530 performs functions of converting the parsing data of the service application received from the user terminal apparatus 120 into binary format data to generate execution data such as a binary execution file and implementing a follow-up measure about the execution of the generated execution data.

To this end, the first processor 530 includes a device manager 540 and the application engine 550. According to an embodiment, the device manager 540 and the application engine 550 may be materialized by programs based on the C/C++ language.

Alternatively, the device manager 540 and the application engine 550 may be materialized by an ASIC and the like hardware.

The device manager 540 controls operations of the application engine 550 in response to a signal received through the second communicator 510.

That is, when the signal is received from the user terminal apparatus 130 through the second communicator 510, the device manager 540 determines whether the received signal is the signal transmitted to the network apparatus 130 based on the ID information included in the received signal.

When it is determined that the received signal is the signal transmitted to the network apparatus 130, the device manager 540 determines whether the received signal is the first service request signal including the parsing data corresponding to the event selection items 410; 411, 412, 413, 414 and/or 415 selected in the user terminal apparatus 120 by a user, on the basis of the data information included in the received signal.

When it is determined that the received signal is the first service request signal including the parsing data, the device manager 540 controls the second communicator 510 to directly transmit the received first service request signal to the application engine 550.

The application engine 550 generates the execution data by converting the parsing data included in the first service request signal received from the second communicator 510 into the binary format data, and implements a follow-up measure about the execution of the generated execution data.

For example, when the parsing data of the received signal is a part of the parsing data corresponding to the front entrance light-off item 411, the application engine 550 converts the part of the parsing data into the binary format data and generates a binary execution file for controlling the light control box 141 to provide the corresponding service. Then, the application engine 550 executes the binary execution file and transmits the control command corresponding to the service to the light control box 141. In response to a control command, the light control box 141 counts the number of people passed through a front entrance by infrared sensors of front entrance lights provided inside and outside the front entrance, and controls the front entrance lights and all other lights to be turned off when all members go out.

Further, when the parsing data of the received signal is of parts of the parsing data corresponding to the front entrance light-off item 411 and the refrigerator recommendation list notification item 413, the application engine 550 generates a binary execution file corresponding to the selected front entrance light-off item 411 and refrigerator recommendation list notification item 413, and executes the generated binary execution file, thereby transmitting control commands relevant to the corresponding services to the light control box 141 and the refrigerator 143. The light control box 141 controls the lights as described above in response to the control command. The refrigerator 143 recognizes a user based on a user image captured by a camera of the refrigerator 143 and user information stored in the storage, makes a request for recent interest information to a mobile phone of the recognized user, generates a recommendation list relevant to the refrigerator 143 based on the received recent interest information, and controls internal elements to display the generated recommendation list on the display of the refrigerator 143.

In the foregoing example, the network apparatus 130 is provided separately from the user terminal apparatus 120 and the passive-control apparatus 140, but not limited thereto. For example, when the user terminal apparatus 120 is materialized by a smart TV, the network apparatus 130 may be internally provided in the user terminal apparatus 120 materialized by the smart TV. Further, when one of the passive-control apparatuses 140 is materialized by the smart TV, the network apparatus 130 may be internally provided in the passive-control apparatus 140 materialized by the smart TV.

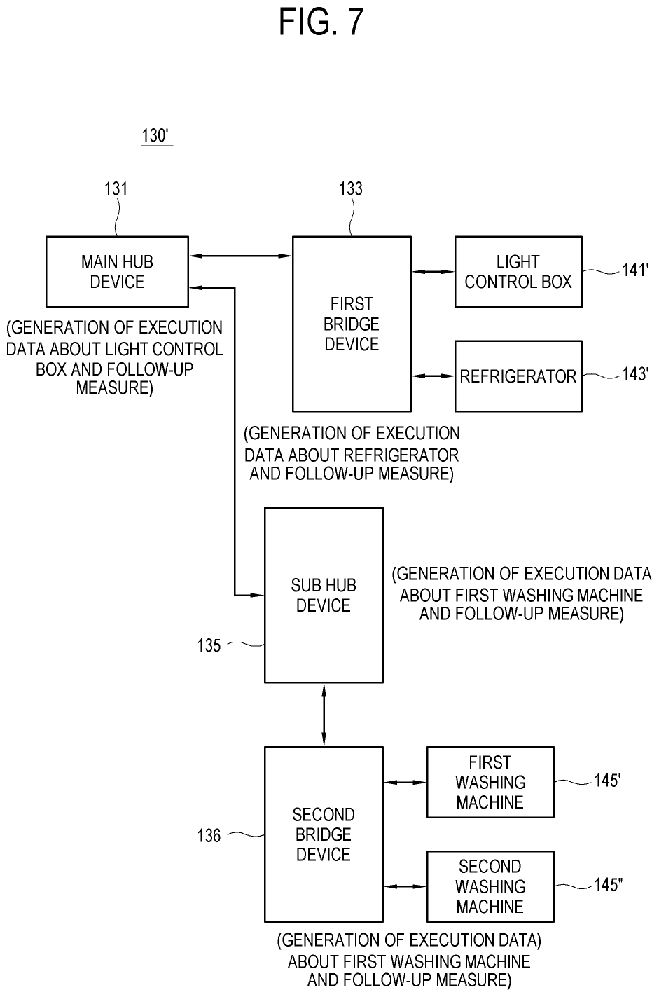

Further, it is illustrated and described that the network apparatus 130 is configured by a single network apparatus, but the present invention is not limited to this configuration. For example, as shown in FIG. 7, a network apparatus 130′ may be materialized by a main hub device 131, a first bridge device 133 connected to the main hub device 131, a sub hub device 135 connected to the main hub device 131, and a second bridge device 136 connected to the sub hub device 135. According to an embodiment, the devices 131, 133, 135 and 136 may have the same configurations as the network apparatus 130 described with reference to FIG. 6. In this case, a light control box 141′, a refrigerator 143′, and first and second washing machines 145′ and 145″ may be distributively connected to the first and second bridge devices 133 and 136. For example, the first bridge device 133 connects with the light control box 141′ and the refrigerator 143′, and the second bridge device 136 connects with the first washing machine 145′ and the second washing machine 145″. In this case, generation of execution data and implementation of a follow-up measure about the parsing data corresponding to the event selection items 410 relevant to the light control box 141′, the refrigerator 143′, and the first and second washing machines 145′ and 145″ are also distributively processed in the main hub device 131, the first bridge device 133, the sub hub device 135 and the second bridge device 136. In result, not only the main hub device 131, the first bridge device 133, the sub hub device 135 and the first hub device 136 can be materialized by devices of a low specification, but also the generation of the execution data and the implementation of the follow-up measure can be quickly performed.

Alternatively, the main hub device 131 may be configured to perform integrated management with regard to the devices 131, 133, 135 and 136 of the network apparatus 130′. For example, the device manager of the main hub device 131 may integrally perform the functions of the respective device managers for controlling the operations of the application engine in response to signals received from the user terminal apparatus 120 to the main hub device 131, the first bridge device 133, the sub hub device 135 and the second hub device 136. In this case, the first bridge device 133, the sub hub device 135 and the second hub device 136 can have specifications lower than that of the main hub device 131, and thus manufacturing costs are reduced.

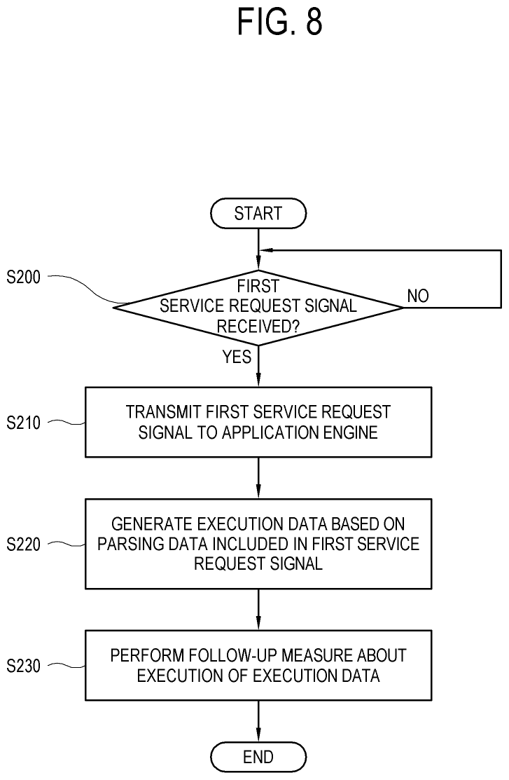

With the foregoing configuration, a control method of the network apparatus 130 according to an exemplary embodiment will be described below with reference to FIG. 8.

First, when a signal is received from the user terminal apparatus 130 through the second communicator 510, the device manger 540 of the second processor 530 determines whether the received signal is a signal transmitted to the network apparatus 130 on the basis of the ID information included in the received signal. When the received signal is the signal transmitted to the network apparatus 130, the device manager 540 determines whether the received signal is the first service request signal including the parsing data corresponding to the event selection item 410; 411, 412, 413, 414 and/or 415, for example, the front entrance light-off item 411 selected in the user terminal apparatus 120 by a user, on the basis of the data information included in the received signal (S200).

When it is determined in the operation S200 that the received signal is the first service request signal including the parsing data, the device manager 540 controls the second communicator 510 to directly transmit the received first service request signal to the application engine 550 (S210).

The application engine 550 converts the parsing data corresponding to the front entrance light-off item 411, included in the first service request signal, from the user terminal apparatus 120 into the binary format data, and generates execution data, for example, a binary execution file for controlling the light control box 141 (S220).

Then, the application engine 550 implements a follow-up measure about the execution of the generated execution data (S230). That is, the second processor 530 executes the generated binary execution file and transmits a control command corresponding to the relevant service to the light control box 141. In response to the control command, the light control box 141 counts the number of people passed through a front entrance by infrared sensors of front entrance lights provided inside and outside the front entrance, and controls the front entrance lights and all other lights to be turned off when all members go out.

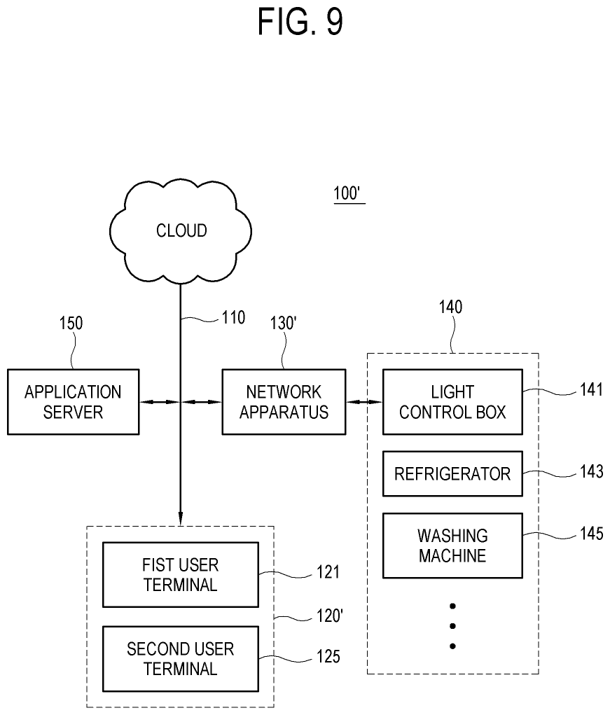

FIG. 9 is a block diagram of an application executing system 100′ according to another exemplary embodiment.

The application executing system 100′ according to exemplary embodiments includes a user terminal apparatus 120′, a network apparatus 130′, and the passive-control apparatuses 140.

The user terminal apparatus 120′ includes first and second user terminal apparatuses 121 and 125.

The first user terminal apparatus 121 refers to an electronic apparatus capable of providing parsing data corresponding to an event like the user terminal apparatus 120 of the application executing system 100 shown in FIG. 2, and have the same configuration and operations as those of the user terminal apparatus 120. Therefore, repetitive detailed descriptions thereof will be avoided.

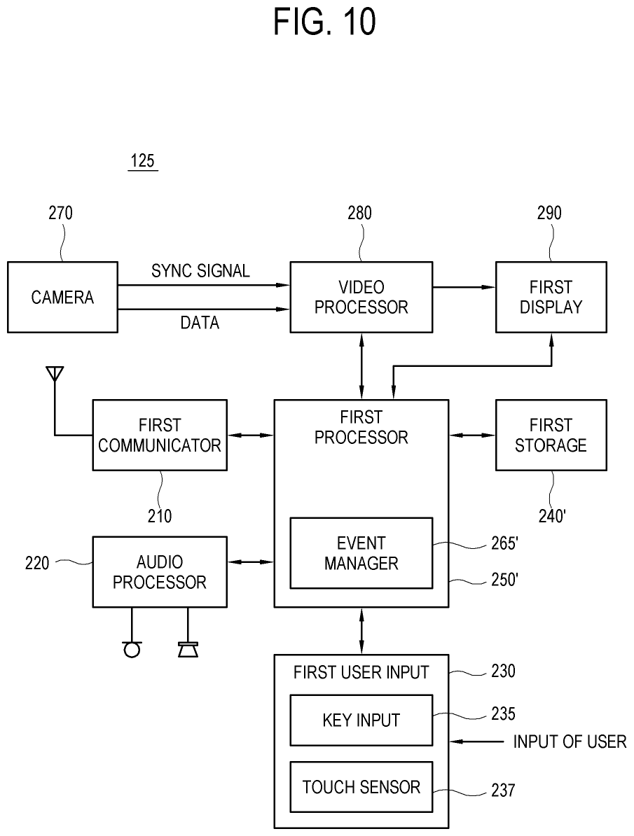

FIG. 10 is a block diagram of the user terminal apparatus 125 according to an exemplary embodiment.

Referring to FIG. 10, the second user terminal apparatus 125 generates only a service request signal (hereinafter, referred to as a ‘second service request signal’) for requesting a service simply corresponding to an event without providing the parsing data corresponding to the event unlike the first user terminal apparatus 121, and transmits the service request signal to the network apparatus 130′.

Therefore, the second user terminal apparatus 125 is the same as the first user terminal apparatus 121 except the first storage 240′ and the first processor 250′. Thus, only the first storage 240′ and the first processor 250′ will be described in detail.

Unlike the first storage 240, the first storage 240′ stores only a remote control application for controlling the passive-control apparatus 140 providing a service corresponding to an event without storing the service application. The remote control application is programmed to generate the second service request signal corresponding to an event selection item 411, 412, 413, 414, and/or 415 selected by a user among the plurality of event selection items 400; 411, 412, 413, 414, 415 when one event selection item is selected on the same selection image as the selection image 400 shown in FIG. 4. The second service request signal refers to an event signal for requesting the service, and includes only the ID information of the passive-control apparatus 140 corresponding to the selected event items 411 and 413 and the data information related to the selected event item information unlike the first service request signal.

The first processor 250′ includes only the event manager 265 unlike the first processor 250 including both the parser 260 and the event manager 265.

When a user selects at least one among a plurality of event selection items 400; 411, 412, 413, 414 and 415 on the selection image 400 displayed after executing the remote control application, the event manager 265 transmits the second service request signals corresponding to the selected event selection item 411, 412, 413, 414, and/or 415 to the network apparatus 130′ to which the light control box 141, the refrigerator 143 and/or the washing machine 145 of the passive-control apparatuses 140 that provide services related to the events corresponding to the selected event items 411, 412, 413, 414, and/or 415.

The other elements of the second user terminal apparatus 125 are the same as those of the first user terminal apparatus 121. Therefore, repetitive detailed descriptions thereof will be avoided.

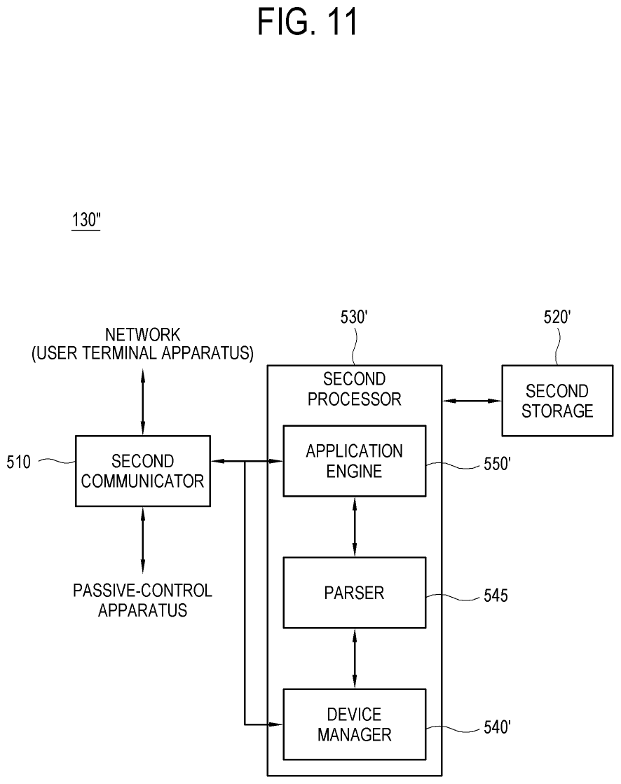

FIG. 11 is a block diagram of a network apparatus 130″ according to another exemplary embodiment.

Referring to FIG. 11, the network apparatus 130″ includes a second communicator 510, a second storage 520′, and a second processor 530′.

The network apparatus 130″ is the same as the network apparatus 130 of the application executing system 100 shown in FIG. 5, except the second storage 520′ and the second processor 530′. Therefore, detailed descriptions about only the second storage 520′ and the second processor 530′ will be made below.

In comparison with the second storage 520, the second storage 520′ is configured to further store the source codes of the service applications corresponding to the services provided by the passive-control apparatuses 140 connected to the network apparatus 130″ corresponding to the plurality of event selection items 400; 411, 412, 413, 414, 415 of the remote control application executed in the user terminal apparatus 120. For example, as shown in FIG. 9, when the light control box 141, the refrigerator 143 and the washing machine 145 are connected as the passive-control apparatuses 140 to the network apparatus 130″, the source codes of the service application corresponding to the services provided by the light control box 141, the refrigerator 143 and the washing machine 145 are stored. The source code of the service application may be previously stored by system design when the application executing system 100 is established, or may be downloaded from the application server 150 or directly input and stored by a user.

The second processor 530′ includes a device manager 540′, an application engine 550′, and a parser 545. According to an embodiment, the device manager 540′, the application engine 550′, and the parser 545 may be materialized by programs written based on the C/C++ language.

Alternatively, the device manager 540′, the application engine 550′, and the parser 545 may be materialized by hardware such as an ASIC.

The device manager 540′, the application engine 550′ and the parser 545′ are configured to perform an integrated function where the functions of the device manager 540 and the application engine 550 of the second processor 530 shown in FIG. 6 and the function of the parser 260 of the first processor 250 shown in FIG. 2 are integrated.

In more detail, when the first service request signal is received from the first user terminal apparatus 121 through the second communicator 510, the device manager 540′ and the application engine 550′ operate like the device manager 540 and the application engine 550 of the second processor 530 shown in FIG. 6. However, when the second service request signal is received from the second user terminal apparatus 125 through the second communicator 510, the device manager 540′ and the application engine 550′ operate unlike the device manager 540 and the application engine 550 of the second processor 530 shown in FIG. 6.

In more detail, when the second service request signal is received from the second user terminal apparatus 125, the device manager 540′ determines the event selection item 411, 412, 413, 414 and/or 415 selected in the second user terminal apparatus 125 by a user, for example, the front entrance light-off item 411, based on the data information included in the second service request signal, and transmits a parsing data request signal for requesting parsing data of a code part of the service application corresponding to the determined front entrance light-off item 411 to the parser 545. The parser 545 generates the parsing data by parsing the code part corresponding to the determined front entrance light-off item 411 among the source codes of the service applications stored in the second storage 520′ in response to the parsing data request signal received from the device manager 545, and transmits the generated parsing data to the application engine 550′. In this case, the generated parsing data and the execution data may be stored in the second storage 520′ in units of the event or the passive-control apparatus. The application engine 550′ generates the execution data based on the parsing data received from the parser 545, and implements a follow-up measure about the execution of the generated execution data. For example, the application engine 550′ generates a binary execution file for controlling the light control box 141 by converting the parsing data received from the parser 545 into a binary format data, and transmits a control command to the corresponding service to the light control box 141 by executing the generated binary execution file. In response to a control command, the light control box 141 counts the number of people passed through a front entrance by infrared sensors of front entrance lights provided inside and outside the front entrance, and controls the front entrance lights and all other lights to be turned off when all members go out.

In the foregoing description, the network apparatus 130″ is the same as the network apparatus 130 and is provided separately from the first or second user terminal apparatus 121 or 125 and the passive-control apparatus 140, but not limited thereto. For example, when the first or second user terminal apparatus 121 or 125 is materialized by the smart TV, the network apparatus 130″ may be internally provided in the first or second user terminal apparatus 121 or 125 materialized by the smart TV. Further, when one of the passive-control apparatuses 140; 141, 143, 145 is materialized by the smart TV, the network apparatus 130″ may be integrally provided in the passive-control apparatus 140; 141, 143 or 145 materialized by the smart TV.

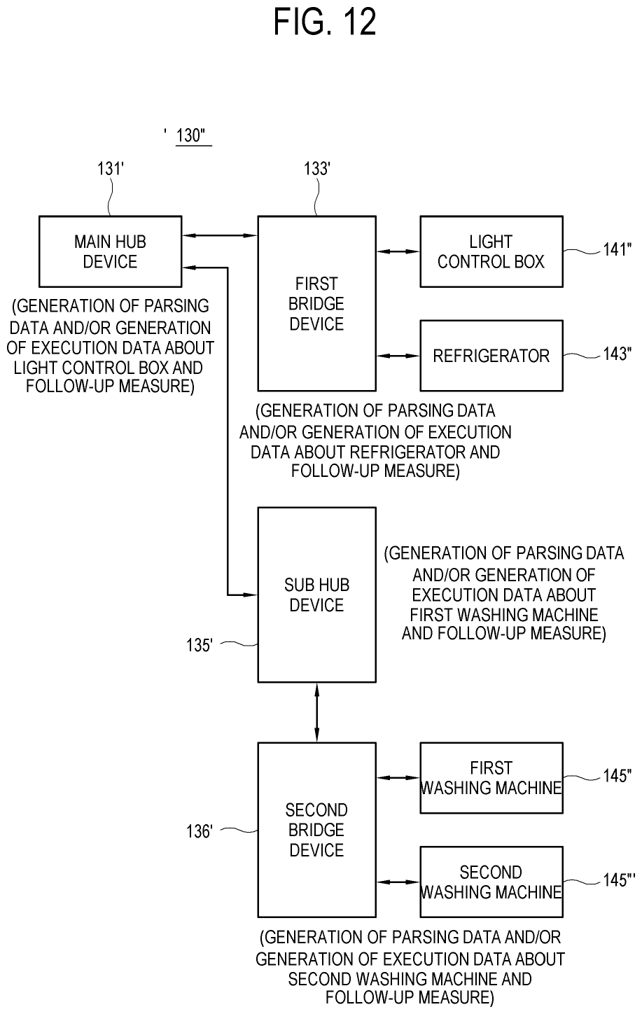

Further, it is illustrated and described that the network apparatus 130″ is configured by a single network apparatus, but the present invention is not limited to this configuration. For example, as shown in FIG. 12, the network apparatus 130′″ may be materialized by the main hub device 131′, a first bridge device 133′ connected to the main hub device 131′, a sub hub device 135′ connected to the main hub device 131′, and a second bridge device 136′ connected to the sub hub device 135′. According to an embodiment, the devices 131′, 133′, 135′ and 136′ may have the same configurations as the network apparatus 130″ described with reference to FIG. 11. In this case, a light control box 141″, a refrigerator 143″, and first and second washing machines 145″ and 145′″ may be distributively connected to the first and second bridge devices 133′ and 136′. For example, the first bridge device 133′ connects with the light control box 141″ and the refrigerator 143″, and the second bridge device 136′ connects with the first washing machine 145″ and the second washing machine 145′″. In this case, generation of parsing data and/or generation of execution data and implementation of a follow-up measure about the code part corresponding to the event selection items 410 relevant to the light control box 141″, the refrigerator 143″, and the first and second washing machines 145″ and 145′″ are also distributively processed in the main hub device 131′, the first bridge device 133′, the sub hub device 135′ and the second bridge device 136′. In result, not only the main hub device 131′, the first bridge device 133′, the sub hub device 135′ and the first hub device 136′ can be respectively materialized by devices of a low specification, but also the generation of the parsing data and/or the generation of the execution data and the implementation of the follow-up measure can be quickly performed.

Alternatively, the main hub device 131′ may be configured to perform integrated management with regard to the network apparatus 130′″. For example, the device manager of the main hub device 131′ may integrally perform the functions of the respective device managers for controlling the operations of the application engine in response to signals received from the first and second user terminal apparatuses 121 and 125 to the main hub device 131′, the first bridge device 133′, the sub hub device 135′ and the second hub device 136′. In this case, the first bridge device 133′, the sub hub device 135′ and the second hub device 136′ can have specifications lower than that of the main hub device 131′, and thus manufacturing costs are reduced.

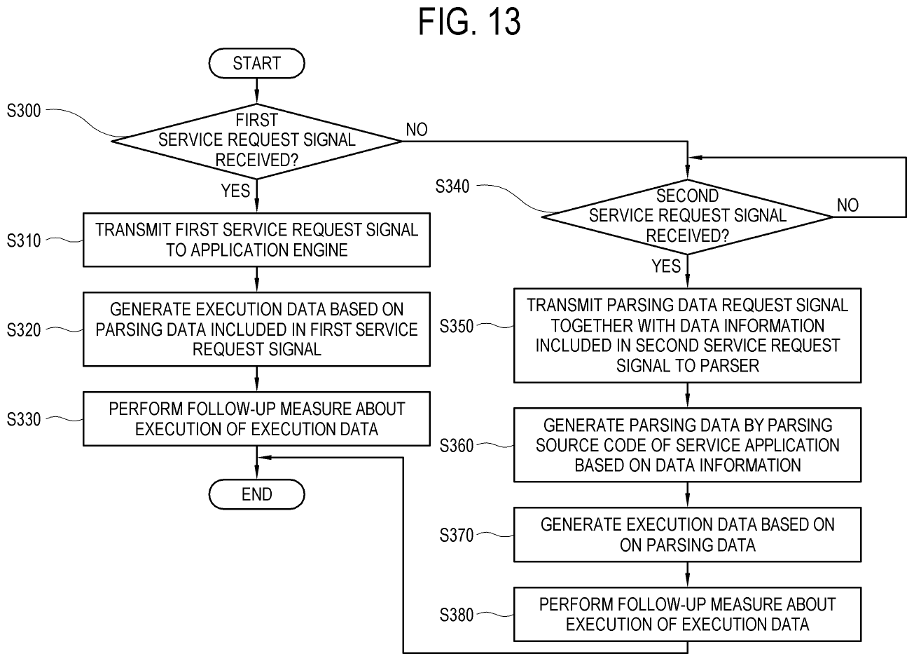

With the foregoing configuration, a control method of the network apparatus 130″ according to an exemplary embodiment will be described below with reference to FIG. 13.

First, when a signal is received through the second communicator 510, the device manger 540′ of the second processor 530′ determines whether the received signal is a signal transmitted to the network apparatus 130″ on the basis of the ID information included in the received signal. When it is determined that the received signal is the signal transmitted to the network apparatus 130″, the device manager 540′ determines whether the received signal is the first service request signal including the parsing data corresponding to the event selection item 410; 411, 412, 413, 414 and/or 415 selected by a user on the basis of the data information included in the received signal (S300).

When it is determined in the operation S300 that the received signal is the first service request signal, the device manager 540′ controls the second communicator 510 to directly transmit the received first service request signal to the application engine 550′ like the device manager 540 of the second processor 530 shown in FIG. 6 (S310). The application engine 550′ also converts the parsing data of the first service request signal received from the second communicator 510 into the binary format data to generate execution data such as a binary execution file like the application engine 550 of the second processor 530 (S320), and implements a follow-up measure about the execution of the generated execution data (S330).

When it is determined in the operation S300 that the received signal is not the first service request signal, the device manager 540′ determines whether the received signal is the second service request signal including only the data information and the ID information about the event selection item 410; 411, 412, 413, 414 and/or 415 selected by a user on the basis of the data information included in the received signal (S340).

When it is determined in the operation S340 that the received signal is the second service request signal, the device manager 540′ transmits the parsing data request signal for requesting the parsing data of the code part of the service execution file corresponding to the selected event selection item 411 and/or 413, together with the data information of the second service request signal about the selected event selection items 411, 412, 413, 414 and/or 415, to the parser 545 (S350).

The parser 545 generates the parsing data by parsing the corresponding code part from the source code of the service application stored in the second storage 520′ on the basis of the data information received from the device manager 540′ and related to the event selection items 411, 412, 413, 414 and/or 415 selected in response to the parsing data request signal, and transmits the generated parsing data to the application engine 550′ (S360).

The application engine 550′ generates the execution data such as the binary execution file by converting the parsing data received from the parser 545 into the binary format data (S370), and implements a follow-up measure about the execution of the generated execution data (S380).

According to the foregoing embodiments, the control method of the user terminal apparatus 120, the information providing method of the network apparatuses 130, 130′, 130″ and 130′″, the service application, and the remote control application may be achieved in the form of program commands to be carried out through various computer means and then recorded in a computer readable medium. The computer readable medium may include a program command, a data file, a data structure, etc. or combination thereof. The program commands recorded in the computer readable medium may be specially designed and configured for the present invention, or publicly known and available for a person having an ordinary skill in the computer software.

As described above, in the user terminal apparatuses 120 and 120′, the network apparatuses 130 and 130′, the application executing systems 100 and 100′ and the control methods thereof according to the embodiments, the user terminal apparatus 120, 121 performs the process of parsing the source code of the service application to execute the service application for providing the service corresponding to the event, and the network apparatus 130, 130′ generates the execution data of the service application and implements the follow-up measure about the execution of the generated execution data. Therefore, the user terminal apparatus 120, 121 and the network apparatus 130, 130′ can execute the service application without using parts of high specifications and/or the JVM. Further, the network apparatus 130, 130′ can easily solve the load of the Communication Overhead even when connecting with a plurality of passive-control apparatuses 140; 141, 141′, 143, 143′, 145, 145′, 145″.

Further, each of the user terminal apparatus 120, 121 and the network apparatus 130, 130′, 130″, 130″ performs the process of parsing the source code of the service application and the generation of the execution data and the follow-up process in units of the event and/or the passive-control apparatus. Therefore, the user terminal apparatus 120, 121 and the network apparatus 130, 130′, 130″, 130′″ may be materialized by apparatuses of lower specifications. Further, the network apparatus 130, 130′, 130″, 130′″ can process the parsing data and/or the execution data more quickly than the conventional one of subjecting the source code of the service application to the Sandbox process in units of the whole script when a runtime error occurs.

Further, when the network apparatus 130′, 130″ are materialized by a plurality of devices 131, 133, 135, 136; 131′, 133′, 135′, 136′ like the network apparatus 130′, 130″, and the passive-control apparatuses 141′, 143′, 145′, 145″; 141″, 143″, 145″, 145′″ are distributively connected to the first and second hub devices 133, 136; 133′, 136′ so that the generation of the parsing data and/or the generation of the execution data and the follow-up measure can be distributively processed, not only the devices 131, 133, 135, 136; 131′, 133′, 135′, 136′ are respectively materialized by apparatuses of lower specifications, but also the generation of the parsing data and/or the generation of the execution data and the follow-up measure are quickly performed.

Further, the parser 260 and the event manager 265, 265′ of the user terminal apparatus 120, 125 and the device manager 540, 540′ of the network apparatus 130, 130′, 130″, 130′″ are materialized by programs written based on the C/C++ language, and thus capable of executing the service application written based on the C/C++ language.

Although the technical features have been described above through the exemplary embodiments, various changes and other equivalent embodiments can be made from these exemplary embodiments by a person having an ordinary skill in the art.

1. An electronic apparatus comprising:
a communicator configured to communicate with a plurality of external electronic apparatuses; and
a processor configured to receive first parsing data, which corresponds to an event that occurs in a first electronic apparatus, of parsing data of an application stored in the first electronic apparatus from the first electronic apparatus among the plurality of external electronic apparatuses, generate first execution data corresponding to the received first parsing data, and perform a follow-up measure about execution of the generated first execution data.

2. The electronic apparatus according to claim 1, wherein the application comprises a script file written based on a script language.

3. The electronic apparatus according to claim 1, wherein the electronic apparatus is provided separately from the plurality of external electronic apparatuses or internally provided in at least one of the plurality of external electronic apparatuses.

4. The electronic apparatus according to claim 1, further comprising a storage configured to store a source code of the application.

5. The electronic apparatus according to claim 4, wherein the processor generates second parsing data, which corresponds to an event that occurs in a second electronic apparatus, based on the source code of the application stored in the storage when receiving an event signal corresponding to the event that occurs in the second electronic apparatus different from the first electronic apparatus among the plurality of external electronic apparatuses, generates second execution data corresponding to the generated second parsing data, and performs a follow-up measure about execution of the generated second execution data.

6. The electronic apparatus according to claim 1, wherein the processor performs a follow-up measure about execution of the generated first execution data with regard to at least one third electronic apparatus different from the first electronic apparatus among the plurality of external electronic apparatuses.

7. The electronic apparatus according to claim 6, wherein
the at least one third electronic apparatus comprises a plurality of third electronic apparatus, and
the electronic apparatus comprises a plurality of electronic apparatuses to which the plurality of third electronic apparatuses are distributively connected.

8. A method of controlling an electronic apparatus, comprising:
receiving first parsing data, which corresponds to an event that occurs in a first electronic apparatus, of parsing data of an application stored in the first electronic apparatus from the first electronic apparatus among the plurality of external electronic apparatuses;
generating first execution data corresponding to the received first parsing data; and
performing a follow-up measure about execution of the generated first execution data.

9. The method according to claim 8, further comprising:
storing a source code of the application;
generating second parsing data, which corresponds to an event that occurs in a second electronic apparatus when receiving an event signal corresponding to the event that occurs in the second electronic apparatus different from the first electronic apparatus among the plurality of external electronic apparatuses;
generating second execution data corresponding to the generated second parsing data; and
performing a follow-up measure about execution of the generated second execution data.

10. An electronic apparatus comprising:
a communicator configured to communicate with a plurality of external electronic apparatuses; and
a storage configured to store parsing data of a predetermined application; and
a processor configured to determine whether an event occurs, and transmit first parsing data, which corresponds to the event, of the parsing data of the application stored in the storage to a first electronic apparatus among the plurality of external electronic apparatuses when the event occurs.

11. The electronic apparatus according to claim 10, wherein the storage is configured to classify and store the parsing data of the predetermined application by a predetermined reference.

12. The electronic apparatus according to claim 11, wherein the predetermined reference comprises units of an event, or units of the electronic apparatus.

13. A method of controlling an electronic apparatus, comprising:
storing parsing data of a predetermined application;
determining whether an event occurs; and
transmitting first parsing data, which corresponds to the event, of the parsing data of the stored application to a first electronic apparatus among the plurality of external electronic apparatuses when the event occurs.

14. The method according to claim 13, wherein the storing comprises classifying and storing the parsing data of the predetermined application by a predetermined reference.

15. An application executing system comprising:
a first electronic apparatus configured to determine whether an event occurs and transmit first parsing data, which corresponds to the event, of parsing data of a stored application when the event occurs; and
a second electronic apparatus configured to receive the first parsing data from the first electronic apparatus, generate first execution data corresponding to the received first parsing data, and perform a follow-up measure about execution of the generated first execution data.
